(19) United States
(12) Patent Application Publication
(10) Pub. No.: US 2015/0125690 A1
(43) Pub. Date: May 7, 2015

(54) TRANSPARENT CONDUCTIVE FILM INCLUDING HYBRID UNDERCOATING LAYER, METHOD FOR MANUFACTURING SAME, AND TOUCH PANEL USING SAME

(71) Applicant: LG Hausys, Ltd., Seoul (KR)

(72) Inventors: Mu-Seon Ryu, Seoul (KR); Won-Kook Kim, Daejeon (KR); Dong-Joo Kwon, Daejeon (KR); Ji-Yeon Seo, Anyang-si (KR)

(21) Appl. No.: 14/399,042

(22) PCT Filed: May 7, 2013
(86) PCT No.: PCT/KR2013/003947

§ 371 Date: Nov. 5, 2014

(30) Foreign Application Priority Data
May 21, 2012 (KR) 10-2012-0053652

(51) Int. Cl. G06F 3/041; H01B 13/00; H01B 1/12; H01B 5/14; H01B 1/08

(52) U.S. Cl. CPC G06F 3/041; H01B 5/14; H01B 1/08; H01B 1/12; H01B 13/0026
USPC 428/336; 427/108

(57) ABSTRACT

Disclosed is a transparent conductive film for a touch panel that uses a single hybrid undercoating layer so as to be capable of index matching and has excellent barrier properties. The conductive film according to the present invention includes: a transparent base material; said hybrid undercoating layer, which is formed on the transparent base material, which consists of an inorganic network/organic network hybrid polymer, which has a refractive index of between 1.55 and 1.7, and which has a thickness of between 10 nm and 1.5 μm; and a transparent conductive layer which is formed on the hybrid undercoating layer. Compared to the transparent conductive films of the prior art, the present invention has significantly higher productivity, has excellent barrier properties, and exhibits stable index matching.

### TECHNICAL FIELD

The present invention relates to a transparent conductive film for touch panels, and more particularly, to a transparent conductive film for touch panels, which enables refractive index matching via a single hybrid undercoating layer and exhibits excellent barrier properties.

### BACKGROUND ART

A transparent conductive film is one of the most important components for touch panels. As the transparent conductive film, an indium tin oxide (ITO) film has been most widely used in the art.

Techniques relating to the transparent conductive film are disclosed in Korean Patent Laid-open Publication No. 10-2001-0030578, and the like.

Typical transparent conductive films employs a transparent polymer film subjected to primer coating and hard coating as a base film to exhibit surface flatness and heat resistance.

On the base film, a transparent undercoating layer is formed by wet coating or vacuum sputtering, followed by forming a transparent conductive layer, such as an ITO layer, by sputtering.

With increasing use of capacitive touch panels in recent years, there is a need for transparent conductive layer patterns having low resistance and high visibility.

Although the transparent conductive layer must have high thickness to realize low resistance, the increase in thickness of the transparent conductive layer can cause deterioration in transmittance. In addition, as the thickness of the transparent conductive layer increases, there is a more severe problem in visibility of the transparent conductive layer after patterning due to difference in index of refraction between the transparent conductive layer and the undercoating layer. As a result, the ITO layer is necessarily thickened to a certain thickness to reduce resistance, and refractive index matching is performed to minimize a difference in index of refraction between such layers. For refractive index matching, several undercoating layers having a different index of refraction are formed between the transparent conductive layer and the transparent base film so as to remove the difference in index of refraction.

However, since there is a problem of significant deterioration in film yield when several undercoating layers are formed, it is necessary to develop a transparent conductive film which enables refractive index matching via a single undercoating layer.

### DISCLOSURE

### Technical Problem

The present invention is conceived to solve such problems in the art, and it is an aspect of the present invention to provide a transparent conductive film for touch panels, which enables refractive index matching via a single hybrid undercoating layer and exhibits excellent barrier properties.

It is another aspect of the present invention to provide a method for preparing a transparent conductive film for touch panels, which enables refractive index matching via a single hybrid undercoating layer and exhibits excellent barrier properties.

### Technical Solution

In accordance with one aspect of the present invention, a transparent conductive film includes: a transparent substrate; a hybrid undercoating layer, which is placed above the transparent substrate, being formed of a hybrid polymer of inorganic network and organic network, and having an index of refraction from 1.55 to 1.7 and a thickness from 10 nm to 1.5 μm; and a transparent conductive layer formed above the hybrid undercoating layer.

In accordance with another aspect of the present invention, a method for preparing a transparent conductive film includes: (a) preparing an inorganic network by hydrolysis and condensation of a metal alkoxide and silicon (Si) alkoxide, followed by addition of a crosslinking agent; (b) preparing an organic network including a polymerizable compound; (c) preparing a composition for formation of a hybrid undercoating layer by mixing the inorganic network and organic network; (d) forming a hybrid undercoating layer having an index of refraction from 1.55 to 1.7 and a thickness from 10 nm to 1.5 μm by coating the composition onto an upper side of a transparent substrate, followed by curing; and (e) forming a transparent conductive layer above the hybrid undercoating layer.

### Advantageous Effects

Since the transparent conductive film according to the present invention uses the single hybrid undercoating layer, there are merits in that the transparent conductive film can exhibit significantly superior productivity to existing transparent conductive films, excellent barrier properties and stable refractive index matching, and is stable against acidic or basic solutions when the transparent conductive layer is etched.

### DESCRIPTION OF DRAWINGS

FIG. 1 is a sectional view showing a structure of a transparent conductive film according to one embodiment of the present invention.

FIG. 2 is a sectional view showing a structure of a typical transparent conductive film.

### BEST MODE

The above and other aspects, features, and advantages of the present invention will become apparent from the detailed description of the following embodiments in conjunction with the accompanying drawings. However, it should be understood that the present invention is not limited to the following embodiments and may be embodied in different ways, and that the embodiments are provided for complete disclosure and thorough understanding of the invention by those skilled in the art. The scope of the invention should be defined only by the accompanying claims and equivalents thereof. Like components will be denoted by like reference numerals throughout the specification.

Hereinafter, a transparent conductive film and a method for manufacturing the transparent conductive film according to the present invention will be described in detail with reference to the accompanying drawings.

### Transparent Conductive Film

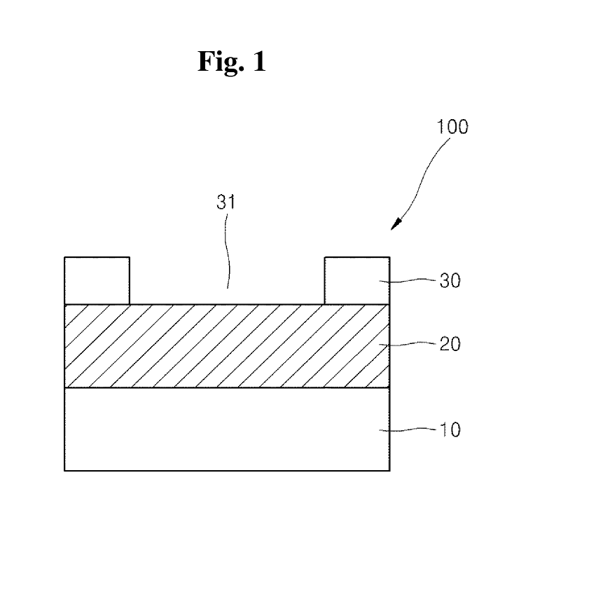

FIG. 1 is a schematic sectional view of a transparent conductive film 100 according to one embodiment of the present invention.

Referring to FIG. 1, the transparent conductive film 100 according to the embodiment of the present invention includes: a transparent substrate 10; a hybrid undercoating layer 20; and a transparent conductive layer 30. As shown in FIG. 1, the transparent conductive layer 30 above the hybrid undercoating layer 20 has a predetermined pattern, and a non-patterned portion 31, in which the conductive layer is removed through a process such as etching, is also formed above the hybrid undercoating layer.

First, the transparent substrate 10 may be composed of a film exhibiting excellent transparency and strength. Materials for the transparent substrate 10 may include polyethylene terephthalate (PET), polyethylene naphthalate (PEN), polyethersulfone (PES), polycarbonate (PC), polypropylene (PP), norbornene resins, and the like. These materials may be used alone or in combination thereof. In addition, the transparent substrate 10 may be prepared in the form of a single film or a stacked film.

The hybrid undercoating layer 20 is formed above the transparent substrate 10. The hybrid undercoating layer 20 may be formed directly above the transparent substrate 10. In addition, a hard coating layer (not shown) may be formed on the upper surface of the transparent substrate 10, and the hybrid undercoating layer 20 may be formed on the hard coating layer.

The hybrid undercoating layer 20 improves insulation properties and transmittance between the transparent substrate 10 and the transparent conductive layer 30.

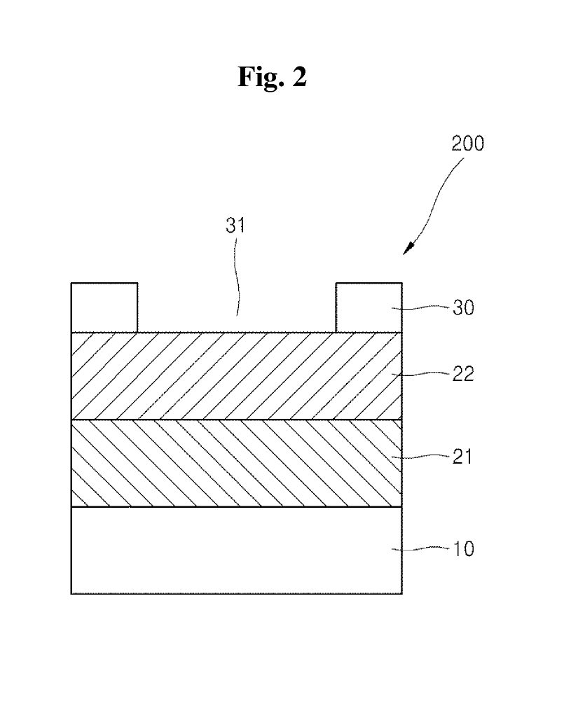

FIG. 2 is a schematic sectional view of a typical transparent conductive film 200. In the existing transparent conductive film 200, a first undercoating layer 21 having a high index of refraction is formed above a transparent substrate 10, and a second undercoating layer 22 having a low index of refraction is formed on the first undercoating layer 21. That is, the typical transparent conductive film 200 employs two or more undercoating layers to minimize a difference in index of refraction due to the patterned transparent conductive layer 30.

On the other hand, the transparent conductive film according to the present invention includes the single hybrid undercoating layer 20. The hybrid undercoating layer 20 is formed of a hybrid polymer of inorganic network and organic network, and has an index of refraction from 1.55 to 1.7 and a thickness from 10 nm to 1.5 μm.

Since the hybrid undercoating layer 20 is formed of the hybrid polymer of the inorganic network and organic network, the hybrid undercoating layer 20 exhibits excellent barrier properties and thus does not inhibit conductivity of the transparent conductive layer. In addition, even though the hybrid undercoating layer 20 is formed as a single layer, the hybrid undercoating layer 20 has an index of refraction from 1.55 to 1.7 and a thickness from 10 nm to 1.5 μm, and thus exhibit high stability in refractive index matching. Preferably, the hybrid undercoating layer 20 has an index of refraction from 1.6 to 1.67 and a thickness from 20 nm to 200 nm.

If the index of refraction of the hybrid undercoating layer is less than 1.55, the transparent conductive film has a problem in that the hybrid undercoating layer is not index-matched well with a substrate due to a large difference in index of refraction therebetween, and if the index of refraction of the hybrid undercoating layer is greater than 1.7, the transparent conductive film also has a problem in refractive index matching due to a difference in index of refraction. In addition, if the thickness of the hybrid undercoating layer is less than 10 nm, the transparent conductive film has a problem due to deterioration in productivity caused by problems in flatness and curvature in the course of a coating process, and if the thickness of the hybrid undercoating layer is greater than 1.5 μm, the transparent conductive film has problems in transparency and refractive index matching.

According to the present invention, the hybrid undercoating layer 20 is formed of a composition including the inorganic network and organic network. The hybrid undercoating layer 20 is formed through a sol-gel process by coating the composition onto the upper side of the transparent substrate 10.

The inorganic network may contain a metal alkoxide and silicon (Si) alkoxide. The metal alkoxide may include at least one of zirconium (Zr) alkoxide and titanium (Ti) alkoxide, and the silicon alkoxide may be alkoxysilane. The inorganic network may include a silane coupling agent so as to participate in photopolymerization and thermal curing with the organic network.

The organic network may contain a polymerizable compound. Specifically, the organic network may contain a polymerizable compound, a polymerization initiator, an additive, and a solvent. The polymerizable compound refers to monofunctional or polyfunctional monomers, oligomers and polymers, which allow photopolymerization or thermal curing. Examples of the polymerizable compound may include urethane acrylates, epoxy acrylates, melamine acrylates, polyester acrylates, and the like. Preferably, the polymerizable compound is at least bifunctional epoxy acrylate containing a phenyl group.

Although the organic network has an index of refraction from 1.5 to 1.59, the composition containing the mixture of the organic and inorganic networks has a high index of refraction from 1.55 to 1.7.

According to the present invention, the transparent conductive film employs the single undercoating layer, and thus exhibits better productivity than typical transparent conductive films including two or more undercoating layers. In addition, even though the hybrid undercoating layer according to the present invention is formed in a single layer, there is a merit in that the hybrid undercoating layer is formed of a hybrid polymer of the organic and inorganic networks and thus exhibits excellent barrier properties. In particular, there are advantages in that the hybrid undercoating layer according to the present invention has a high index of refraction of 1.55 to 1.7 due to mixing of the organic and inorganic networks, and enables stable refractive index matching when the thickness thereof is in the range of 10 nm to 1.5 μm. Further, since the hybrid undercoating layer is formed by mixing the organic and inorganic networks, the hybrid undercoating layer is more stable in an acidic or basic solution than existing undercoating layers upon an etching process for pattern formation of the transparent conductive layer.

According to the present invention, the transparent conductive film may further include a hard coating layer (not shown) formed of an acrylic compound on one or both surfaces of the transparent substrate 10 in order to improve surface hardness.

The hard coating layer may be formed on one or both surfaces of the transparent substrate 10 on which the hybrid undercoating layer 20 is not formed, and may be formed only on a lower surface of the transparent substrate 10 including the hybrid undercoating layer 20 formed thereon.

### Method for Manufacturing Transparent Conductive Film

According to one embodiment of the invention, a method for preparing a transparent conductive film includes: (a) preparing an inorganic network; (b) preparing an organic network; (c) preparing a composition for formation of a hybrid undercoating layer by mixing the inorganic network and organic network; (d) forming a hybrid undercoating layer using the composition; and (e) forming a transparent conductive layer above the hybrid undercoating layer.

In operation (a), a metal alkoxide and silicon (Si) alkoxide are subjected to hydrolysis and condensation, followed by addition of a crosslinking agent, thereby preparing the inorganic network. For efficient hydrolysis and condensation, the metal alkoxide may be coordinated using a material such as acetic acid, followed by hydrolysis and condensation of the coordinated metal alkoxide with the silicon (Si) alkoxide. Then, the inorganic network is finally prepared through surface modification in which a crosslinking agent such as a silane coupling agent is added such that the inorganic network can participate in photopolymerization and thermal curing.

In operation (b), the organic network including a polymerizable compound, such as monofunctional or polyfunctional monomers, oligomers and polymers capable of photopolymerization or thermal curing, is prepared.

Operation (a) and operation (b) may be performed regardless of sequence.

In operation (c), the inorganic network prepared through operation (a) and the organic network prepared through operation (b) are mixed with each other, thereby preparing a composition for formation of a hybrid undercoating layer.

Next, in operation (d), the composition is coated onto an upper side of a transparent substrate, followed by curing, thereby forming a hybrid undercoating layer having an index of refraction from 1.55 to 1.7 and a thickness from 10 nm to 1.5 μm. Here, the hybrid undercoating layer is formed by a sol-gel process.

In operation (e), the transparent conductive layer is formed on the upper side of the hybrid undercoating layer. The transparent conductive layer may be formed by any method known in the art, such as sputtering, and the like.

Through a series of the aforementioned processes, the transparent conductive film according to the present invention can be manufactured.

According to the present invention, the transparent conductive film may be used for touch panels.

Hereinafter, the present invention will be described in more detail with reference to some examples. It should be understood that these examples are not to be construed in any way as limiting the present invention.

### EXAMPLE 1

Acetic acid was added to a mixture of zirconium alkoxide and an alcohol solvent to coordinate the zirconium alkoxide. The zirconium alkoxide and alkoxysilane were subjected to hydrolysis and condensation, followed by surface modification with a silane coupling agent, thereby preparing an inorganic network.

An organic network was prepared using a composition including a phenyl group-containing epoxy acrylate prepolymer and a photoinitiator.

Then, the prepared inorganic network and organic network were mixed with each other, thereby preparing a composition for formation of a hybrid undercoating layer.

The composition was coated onto one surface of a PET film, followed by curing through UV irradiation, thereby forming a hybrid undercoating layer. The hybrid undercoating layer had a thickness of 500 nm and an index of refraction of 1.63.

A 20 nm thick ITO layer was formed on an upper side of the hybrid undercoating layer by sputtering, followed by patterning of the ITO layer, thereby preparing a transparent conductive film.

### EXAMPLE 2

A transparent conductive film was prepared in the same manner as in Example 1 except that the inorganic network was prepared using titanium alkoxide instead of zirconium alkoxide and that the hybrid undercoating layer had a thickness of 150 nm Here, the hybrid undercoating layer had an index of refraction of 1.66.

### EXAMPLE 3

Using a radical initiator corresponding to a thermal initiator, a hybrid polymer including a phenyl group, such as a styrene monomer, and an acrylate silane monomer was polymerized to prepare an organic network.

Acetic acid was added to a mixture of zirconium alkoxide and an alcohol solvent to coordinate the zirconium alkoxide. The zirconium alkoxide and alkoxysilane were subjected to hydrolysis and condensation, followed by surface modification with a silane coupling agent, thereby preparing an inorganic network.

Then, the prepared inorganic network and organic network were mixed with each other, thereby preparing a composition for formation of a hybrid undercoating layer.

The composition was coated onto one surface of a PET film, followed by curing through UV irradiation, thereby forming a hybrid undercoating layer. The hybrid undercoating layer had a thickness of 1 μm and an index of refraction of 1.60.

A 20 nm thick ITO layer was formed on an upper side of the hybrid undercoating layer by sputtering, followed by patterning of the ITO layer, thereby preparing a transparent conductive film.

### Comparative Example 1

A transparent conductive film was prepared in the same manner as in Example 1 except that the hybrid undercoating layer had a thickness of 5 nm. Here, the hybrid undercoating layer had an index of refraction of 1.63.

### Comparative Example 2

A transparent conductive film was prepared in the same manner as in Example 1 except that the hybrid undercoating layer had a thickness of 2 μm. Here, the hybrid undercoating layer had an index of refraction of 1.63.

### Comparative Example 3

A transparent conductive film was prepared in the same manner as in Example 1 except that a 50 nm thick SiO₂ film was formed instead of the hybrid undercoating layer of Example 1. Here, the hybrid undercoating layer formed of SiO₂ had an index of refraction of 1.47.

### Evaluation

Each of the transparent conductive films prepared in Examples and Comparative Examples was evaluated as to refractive index matching for an etching pattern of the ITO layer, and results are shown in Table 1.

Refractive index matching was evaluated by observing optical properties of the etching pattern of the ITO layer and whether the etching pattern was visible to the naked eye. A transparent conductive film exhibiting excellent refractive index matching was rated O, and a transparent conductive film exhibiting insufficient refractive index matching was rated X.

TABLE 1

| | | Thick- | Index of | | | Result |
|---|---|---|---|---|---|---|
| | | ness | refraction | | | of refrac- |
| | Under- | of under- | of under- | | | tive |
| | coating | coating | coating | | | index |
| | layer | layer | layer | ΔT | ΔR | matching |
| Example 1 | Hybrid under- | 500 nm | 1.63 | 0.2 | 0.5 | O |
| | coating layer | | | | | |
| Example 2 | Hybrid under- | 150 nm | 1.66 | 0.4 | 0.6 | O |
| | coating layer | | | | | |
| Example 3 | Hybrid under- | 1 μm | 1.60 | 0.3 | 0.5 | O |
| | coating layer | | | | | |
| Comparative | Hybrid under- | 5 nm | 1.63 | 1.0 | 1.1 | X |
| Example 1 | coating layer | | | | | |
| Comparative | Hybrid under- | 2 μm | 1.63 | 0.9 | 1.2 | X |
| Example 2 | coating layer | | | | | |
| Comparative | SiO₂ | 50 nm | 1.47 | 2.1 | 2.0 | X |
| Example 3 | | | | | | |

ΔT = difference in light transmittance between ITO layer-removed portion and ITO layer-unremoved portion after deposition of ITO layer
ΔR = difference in light reflectance between ITO layer-removed portion and ITO layer-unremoved portion after deposition of ITO layer

Optical properties were measured using a CM-5 (Konica Minolta Co., Ltd.).

From the results of Table 1, since the transparent conductive films of Examples 1 to 3 had a small difference in light transmittance and light reflectance of 0.5 or less between the ITO layer-removed portion and the ITO layer-unremoved portion after deposition of the ITO layer, the transparent conductive films of Examples 1 to 3 were evaluated to exhibit good refractive index matching. In addition, it could be seen that the transparent conductive films of Examples exhibited excellent refractive index matching, since it was difficult to identify the ITO etching pattern by the naked eye. On the other hand, the transparent conductive films of Comparative Examples had a larger difference in light transmittance and light reflectance than those of Examples, and were evaluated to exhibit insufficient refractive index matching through observation with the naked eye.

It could be seen that, although the transparent conductive films of Examples 1 to 3 included the single undercoating layer between the transparent conductive layer and the transparent substrate, since the undercoating layer was formed of the inorganic network and organic network and had a thickness and an index of refraction satisfying specific ranges, respectively, the transparent conductive films of Examples 1 to 3 exhibited excellent refractive index matching.

It could be seen that, although the hybrid undercoating layer was used, the transparent conductive films of Comparative Examples 1 and 2 exhibited insufficient refractive index matching due to excessively thin or thick thickness of the hybrid undercoating layer.

It could be seen that the transparent conductive film of Comparative Example 3, in which only a single undercoating layer formed of SiO₂ was used, exhibited insufficient refractive index matching.

Although the present invention has been described with reference to some embodiments, it should be understood that various modifications, changes, alterations, and equivalent embodiments can be made by those skilled in the art without departing from the spirit and scope of the invention. Therefore, the scope of the invention should be limited only by the accompanying claims.

1. A transparent conductive film comprising:
a transparent substrate;
a hybrid undercoating layer, which is placed above the transparent substrate, being formed of a hybrid polymer of inorganic network and organic network, and having an index of refraction from 1.55 to 1.7 and a thickness from 10 nm to 1.5 82 m; and
a transparent conductive layer formed above the hybrid undercoating layer.

2. The transparent conductive film according to claim 1, wherein the inorganic network comprises a metal alkoxide and silicon (Si) alkoxide.

3. The transparent conductive film according to claim 2, wherein the metal alkoxide comprises at least one of zirconium (Zr) alkoxide and titanium (Ti) alkoxide.

4. The transparent conductive film according to claim 1, wherein the organic network comprises a polymerizable compound.

5. The transparent conductive film according to claim 4, wherein the polymerizable compound comprises at least one of thermally polymerizable or photopolymerizable monomers, oligomers and polymers having at least one functional group.

6. The transparent conductive film according to claim 1, wherein the transparent substrate is a monolayer or stacked film formed of at least one of polyethylene terephthalate (PET), polyethylene naphthalate (PEN), polyethersulfone (PES), polycarbonate (PC), polypropylene (PP), and norbornene resins.

7. The transparent conductive film according to claim 1, wherein the transparent conductive layer comprises indium tin oxide (ITO) or fluorine-doped tin oxide (FTO).

8. The transparent conductive film according to claim 1, further comprising:
a hard coating layer formed on one or both surfaces of the transparent substrate.

9. A method for preparing a transparent conductive film comprising:
(a) preparing an inorganic network by hydrolysis and condensation of a metal alkoxide and silicon (Si) alkoxide, followed by addition of a crosslinking agent;
(b) preparing an organic network comprising a polymerizable compound;
(c) preparing a composition for formation of a hybrid undercoating layer by mixing the inorganic network and organic network;
(d) forming a hybrid undercoating layer having an index of refraction from 1.55 to 1.7 and a thickness from 10 nm to 1.5 μm by coating the composition onto an upper side of a transparent substrate, followed by curing; and
(e) forming a transparent conductive layer on an upper side of the hybrid undercoating layer.

10. A touch panel comprising the transparent conductive film according to claim 1.
